(19) United States
(12) Patent Application Publication
(10) Pub. No.: US 2017/0013231 A1
(43) Pub. Date: Jan. 12, 2017

(54) DISPLAY APPARATUS, WIRELESS COMMUNICATION APPARATUS AND CONTROL METHOD THEREOF

(71) Applicant: SAMSUNG ELECTRONICS CO., LTD., Suwon-si (KR)

(72) Inventor: Oh-yun KWON, Seoul (KR)

(73) Assignee: SAMSUNG ELECTRONICS CO., LTD., Suwon-si (KR)

(21) Appl. No.: 15/203,076

(22) Filed: Jul. 6, 2016

(30) Foreign Application Priority Data
Jul. 8, 2015 (KR) 10-2015-0097401

(51) Int. Cl. H04N 7/01; H04N 21/485; H04N 21/4363; H04N 21/4402; G06F 3/0482; G06F 3/0484

(52) U.S. Cl. CPC H04N 7/0122; G06F 3/0482; G06F 3/04847; H04N 21/4363; H04N 21/440272; H04N 21/4858

(57) ABSTRACT

Disclosed is a display apparatus comprising: a signal receiver configured to receive a first image signal having a predetermined resolution from an external apparatus; a signal processor configured to process the received first image signal; a display having a screen on which a first image of the processed first image signal is displayed; and a controller configured to: send a request for an image signal different in resolution from the received first image signal to the external apparatus, receive a second image signal having the different resolution from the external apparatus, control the signal processor to adjust a size of a second image of the received second image signal having the different resolution based on a size of the screen of the display, and control the display to display the second image having the adjusted size.

### CROSS-REFERENCE TO RELATED THE APPLICATIONS

This application claims priority from Korean Patent Application No. 10-2015-0097401 filed on Jul. 8, 2015 in the Korean Intellectual Property Office, the disclosure of which is incorporated herein by reference.

### BACKGROUND

I. Field

Apparatuses and methods consistent with the exemplary embodiments relate to a display apparatus, a wireless communication apparatus and a control method thereof, and more particularly to a display apparatus, a wireless communication apparatus and a control method thereof, which can adjust a resolution of an image signal received from an externa device.

II. Description of the Related Art

To make a television (TV) monitor display a content image received from a personal computer (PC) or the like external apparatus, it is checked through a display data channel (DDC) communicator whether extended display identification data (EDID) is matched between the PC and the TV monitor. If the EDID is matched between the PC and the TV monitor, a content image not higher than a supportable resolution is displayed on the TV monitor.

On the other hand, if a content image a user wants to view is input having a resolution higher than that supportable in the TV monitor, the TV monitor may display a massage of ‘no support image’ through on screen display (OSD) without displaying this content image.

Further, if a content image having a high resolution for a game, sports or the like is displayed on a display of supporting a low resolution, the content image is not entirely displayed but partially displayed, for example, as if left and right areas thereof are cut away. Therefore, a user misses information corresponding to the cut-away areas while viewing the displayed image.

### SUMMARY

Accordingly, an aspect of one or more exemplary embodiments may provide a display apparatus for receiving an image signal different in resolution from a signal received from an external apparatus, and a control method thereof.

Another aspect may provide a wireless communication apparatus for sending an electronic apparatus a stream of an image which is different in resolution from an image requested by the electronic apparatus, and a control method thereof.

In accordance with an exemplary embodiment, there is provided a display apparatus that may comprise: a signal receiver configured to receive an image signal having a predetermined resolution from an external apparatus; a signal processor configured to process the received image signal; a display configured to have a screen on which an image is displayed based on the processed image signal; and a controller configured to: send a request for an image signal different in resolution from the image signal, which has been being received, to the external apparatus, receive the image signal having the different resolution from the external apparatus, controls the signal processor to adjust the size of an image based on the received image signal having the different resolution in accordance with the size of the screen of the display, and control the display to display the image having the adjusted size.

According to an exemplary embodiment, an image signal different in resolution from the receiving image signal is received from the external apparatus in response to a user's request, and displayed as an image having a size desired by a user, thereby improving a user's view area. Further, it is advantageously possible to receive and display an image even when the resolution of the image provided by the external apparatus is different from the resolution supportable in the display apparatus.

The display apparatus may further comprise an input receiver configured to receive input of a user and the controller may make a request for the image signal having the different resolution to the external apparatus in response to the received input. Thus, an image signal is received having a resolution desired by a user based on the user setting and displayed on the screen.

The input may comprise at least one of a selection from a user interface (UI) menu, input of a shortcut key, voice and motion. Thus, a user can set a desired resolution of an image by a shortcut key, voice, motion or the like simple method in addition to the method of selecting a menu on the screen.

The display apparatus may further comprise a storage configured to store information about resolutions supportable by the display apparatus in an memory area to be accessed by the external apparatus for transmitting the image signal, and the controller may change information stored in the storage in accordance with the different resolution. Thus, information about the resolutions, stored in the EDID table, where resolution information of a TV is stored, is changed, and it is thus possible to receive an image signal having a resolution not supported in the TV.

The controller may send a request for information about transmittable resolutions to the external apparatus, and control the display to display a UI showing information about the transmittable resolutions received from the external apparatus. Thus, information about a list of resolutions that can be provided by the external apparatus is displayed on the screen, so that a user can select an image having a desired resolution.

The controller may select one transmittable resolution from among the transmittable resolutions in response to a user's input to the UI, and make a request for an image signal having the selected resolution to the external apparatus. Thus, a user selects one of resolutions that can be provided by the external apparatus, so that an image having a desired resolution can be received.

The signal processor may comprise a scaler configured to apply scaling to the image based on the received image signal having the different resolution with respect to at least one of a horizontal direction and a vertical direction. Thus, it is possible to adjust the size of the image received from the external apparatus in accordance with the size of the screen.

The controller may control the display to display a user setting UI for allowing a user to set scaling areas and scaling ratios for the image based on the received image signal having the different resolution, and control the scaler to apply scaling to the image based on the received image signal having the different resolution in response to a user's input to the displayed user setting UI. Thus, when the size of the received image is adjusted, a user may directly designate the partial area to be subjected to scaling through the UI menu or set the scaling ratios.

The controller may control the display to display an original view area, which corresponds to the image signal that has been being received having the predetermined resolution, and an additional view area, which corresponds to the image signal having the different resolution and is added to the original view area, when the image having the adjusted size is displayed. Thus, if the TV receives an image having a resolution higher than the supportable resolution, it is possible to display an original area for displaying an image having the resolution supportable by the TV, and an additional area additionally displayed based on the image having the higher resolution received in response to the request.

The controller may apply different scaling ratios to the original view area and the additional view area, respectively. Thus, the original area for displaying the image having the resolution supportable by the TV, and the additional area additionally displayed based on the image having the higher resolution received in response to the request are respectively subject to the different scaling ratios, thereby adjusting the amount of information involved in the areas.

The controller may apply down-scaling to an image based on an image signal having a resolution higher than the resolution of the receiving image signal in accordance with the screen size of the display if the image signal having the higher resolution is received from the external apparatus, and may apply up-scaling to an image based on an image signal having a resolution lower than the resolution of the receiving image signal in accordance with the screen size of the display if the image signal having the lower resolution is received from the external apparatus. Thus, when the size of the image is adjusted by receiving the image signal having the different resolution, it is possible to enlarge or reduce the image in accordance with the size of the screen.

The controller may make a request for an image signal different in aspect ratio from the receiving image signal to the external apparatus, and receive the image signal having the different aspect ratio from the external apparatus. Thus, an image signal different in aspect ratio from the receiving image signal from the external apparatus is received in response to a user's request, and it is therefore convenient for a user to display an image as desired by him/her.

The external apparatus may comprise a wireless communication apparatus wirelessly connected with the display apparatus, and the controller may stream an image signal having a predetermined resolution from the wireless communication apparatus, make a request for an image signal different in resolution from the streaming image signal, and stream the image signal having the different resolution from the wireless communication apparatus. Thus, if a stream of an image is received from a smart phone or the like wireless communication apparatus, a user makes a request for an image having a desired resolution and so that an image having the requested resolution can be streamed.

In accordance with an exemplary embodiment, there is provided a wireless communication apparatus comprising: a display configured to display an image based on an image signal; a communicator configured to wirelessly connect with an electronic apparatus and stream and transmit an image signal having a predetermined resolution to the electronic apparatus; and a controller configured to control the communicator to stream and transmit an image signal different in resolution from the streaming image signal to the electronic apparatus in response to a request for the image signal having the different resolution from the electronic apparatus.

According to an exemplary embodiment, if the stream of the image is transmitted from the smart phone or the like wireless communication apparatus to the TV, the image different in resolution from the transmitted image can be transmitted in response to the request of the TV.

The controller may execute an application for streaming and transmitting an image signal having a predetermined resolution to the electronic apparatus in response to a user's input. Thus, a predetermined application is executed in the smart phone or the like wireless communication apparatus so that the stream of the image can be transmitted to the TV.

The controller may receive a request for an image signal different in resolution from the streaming image signal from the electronic apparatus, and change the resolution of the image signal into the different resolution or determines whether there is a file corresponding to the image signal having the different resolution in response to the request. Thus, it is possible to stream and transmit the image having the requested resolution to the TV by changing the resolution of the image signal or searching an image file having the requested resolution, so that the smart phone or the like wireless communication apparatus can stream and transmit the image having the resolution requested from the TV.

In accordance with an exemplary embodiment, there is provided a method of controlling a display apparatus, the method comprising: receiving an image signal having a predetermined resolution from an external apparatus; making a request for an image signal, which is different in resolution from the image signal that has been being received, to the external apparatus; receiving the image signal having the different resolution from the external apparatus; adjusting the size of an image based on the received image signal having the different resolution in accordance with the size of the screen of the display; and displaying the image having the adjusted size.

According to an exemplary embodiment, an image signal different in resolution from the receiving image signal is received from the external apparatus in response to a user's request, and displayed as an image having a size desired by a user, thereby improving a user's view area. Further, it is advantageously possible to receive and display an image even when the resolution of the image provided by the external apparatus is different from the resolution supportable in the display apparatus.

The method may further comprise receiving input of a user; and making a request for the image signal having the different resolution to the external apparatus in response to the received input. Thus, an image signal is received having a resolution desired by a user based on the user setting and displayed on the screen.

The input may comprise at least one of selection from a UI menu, input of a shortcut key, voice and motion. Thus, a user can set a desired resolution of an image by a shortcut key, voice, motion or the like simple method in addition to the method of selecting a menu on the screen.

The method may further comprise: storing information about resolutions supportable by the display apparatus in an memory area to be accessed by the external apparatus for transmitting the image signal; and changing the stored information in accordance with the different resolution. Thus, information about the resolutions, stored in the EDID table, where resolution information of a TV is stored, is changed, and it is thus possible to receive an image signal having a resolution not supported in the TV.

The method may further comprise: making a request for information about transmittable resolutions to the external apparatus; and displaying a UI showing information about the transmittable resolutions received from the external apparatus. Thus, information about a list of resolutions that can be provided by the external apparatus is displayed on the screen, so that a user can select an image having a desired resolution.

The method may further comprise: selecting one among the transmittable resolutions in response to a user's input to the UI; and making a request for an image signal having the selected resolution to the external apparatus. Thus, a user selects one of resolutions that can be provided by the external apparatus, so that an image having a desired resolution can be received.

The adjusting the size of the image may comprise applying scaling to the image based on the received image signal having the different resolution with respect to at least one of horizontal and vertical directions. Thus, it is possible to adjust the size of the image received from the external apparatus in accordance with the size of the screen.

The method may further comprise: displaying a user setting UI for allowing a user to set scaling areas and scaling ratios for the image based on the received image signal having the different resolution; and applying scaling to the image based on the received image signal having the different resolution in response to a user's input to the displayed user setting UI. Thus, when the size of the received image is adjusted, a user may directly designate the partial area to be subjected to scaling through the UI menu or set the scaling ratios.

The displaying the image having the adjusted size may comprise displaying an original view area, which corresponds to the image signal that has been being received having a predetermined resolution, and an additional view area, which corresponds to the image signal having the different resolution and is added to the original view area. Thus, if the TV receives an image having a resolution higher than the supportable resolution, it is possible to display an original area for displaying an image having the resolution supportable by the TV, and an additional area additionally displayed based on the image having the higher resolution received in response to the request.

The adjusting the size of the image may comprise applying different scaling ratios to the original view area and the additional view area, respectively. Thus, the original area for displaying the image having the resolution supportable by the TV, and the additional area additionally displayed based on the image having the higher resolution received in response to the request are respectively subject to the different scaling ratios, thereby adjusting the amount of information involved in the areas.

The method may further comprise: applying down-scaling to an image based on an image signal having a resolution higher than the resolution of the receiving image signal in accordance with the screen size of the display if the image signal having the higher resolution is received from the external apparatus; and applying up-scaling to an image based on an image signal having a resolution lower than the resolution of the receiving image signal in accordance with the screen size of the display if the image signal having the lower resolution is received from the external apparatus. Thus, when the size of the image is adjusted by receiving the image signal having the different resolution, it is possible to enlarge or reduce the image in accordance with the size of the screen.

The method may further comprise: making a request for an image signal different in aspect ratio from the receiving image signal to the external apparatus; and receiving the image signal having the different aspect ratio from the external apparatus. Thus, an image signal different in aspect ratio from the receiving image signal from the external apparatus is received in response to a user's request, and it is therefore convenient for a user to display an image as desired by him/her.

The external apparatus may comprise a wireless communication apparatus wirelessly connecting with the display apparatus, and the method further comprises: streaming an image signal having a predetermined resolution from the wireless communication apparatus; making a request for an image signal different in resolution from the streaming image signal, and streaming the image signal having the different resolution from the wireless communication apparatus. Thus, if a stream of an image is received from a smart phone or the like wireless communication apparatus, a user makes a request for an image having a desired resolution and so that an image having the requested resolution can be streamed.

In accordance with an exemplary embodiment, there is provided a method of controlling a wireless communication apparatus, the method comprising: wirelessly connecting with an electronic apparatus and streaming and transmitting an image signal having a predetermined resolution to the electronic apparatus; receiving a request for an image signal different in resolution from the streaming image signal from the electronic apparatus; and streaming and transmitting the image signal having the different resolution to the electronic apparatus.

According to an exemplary embodiment, if the stream of the image is transmitted from the smart phone or the like wireless communication apparatus to the TV, the image different in resolution from the transmitted image can be streamed in response to the request of the TV.

The method may further comprise executing an application for streaming and transmitting an image signal having a predetermined resolution to the electronic apparatus in response to a user's input. Thus, a predetermined application is executed in the smart phone or the like wireless communication apparatus so that the stream of the image can be transmitted to the TV.

The method may further comprise: receiving a request for an image signal different in resolution from the streaming image signal from the electronic apparatus, and changing the resolution of the image signal into the different resolution or determining whether there is a file corresponding to the image signal having the different resolution in response to the request. Thus, it is possible to stream and transmit the image having the requested resolution to the TV by changing the resolution of the image signal or searching an image file having the requested resolution, so that the smart phone or the like wireless communication apparatus can stream and transmit the image having the resolution requested from the TV.

### BRIEF DESCRIPTION OF THE DRAWINGS

The above and/or other aspects will become apparent and more readily appreciated from the following description of exemplary embodiments, taken in conjunction with the accompanying drawings, in which:

FIG. 1 is a block diagram of a display apparatus according to an exemplary embodiment;

FIG. 2 is a block diagram of a display apparatus according to an exemplary embodiment;

FIG. 3 is a flowchart showing a method of controlling a display apparatus according to an exemplary embodiment;

FIG. 4 is a flowchart showing a method of controlling a display apparatus according to an exemplary embodiment;

FIG. 5 is a flowchart showing a scaling process with regard to a received image having a different resolution according to an exemplary embodiment;

FIG. 6 is a flowchart showing a control method of a wireless communication apparatus according to an exemplary embodiment;

FIG. 7 illustrates a process that a television (TV) receives an image having a different resolution from a personal computer (PC) by changing extended display identification data (EDID) information according to an exemplary embodiment;

FIG. 8 illustrates a process that a TV receives a stream of an image having a different resolution from a smart phone according to an exemplary embodiment;

FIG. 9 illustrates an example of displaying an image having a resolution supported by a TV according to an exemplary embodiment;

FIG. 10 illustrates an example of a user interface (UI) for informing that a resolution of an image displayed on a TV is changeable according to an exemplary embodiment;

FIG. 11 illustrates an example of a UI for setting a resolution, through which the resolution of the image displayed on the TV can be set according to an exemplary embodiment;

FIG. 12 illustrates an example of changing the resolution of the image displayed on the TV by a remote controller according to an exemplary embodiment;

FIG. 13 illustrates an example of changing the resolution of the image displayed on the TV by a user's voice command according to an exemplary embodiment;

FIG. 14 illustrates an example of changing the resolution of the image displayed on the TV by motion recognition according to an exemplary embodiment;

FIG. 15 illustrates an example of an original view area corresponding to a resolution of an image, which has been received, and an additional view area corresponding to a different resolution of an image, which is being received, according to an exemplary embodiment;

FIG. 16 illustrates an example of a UI for setting respective scaling ratios with regard to the original view area and the additional view area according to an exemplary embodiment;

FIG. 17 illustrates an example of displaying content having a format of ‘21:9’ on a screen of ‘16:9’ and a screen of ‘21:9’ according to an exemplary embodiment;

FIG. 18 illustrates an example of applying no scaling when content having a format of ‘21:9’ is displayed on a screen of ‘16:9’ according to an exemplary embodiment;

FIG. 19 illustrates an example of applying down-scaling in horizontal and vertical directions when content having a format of ‘21:9’ is displayed on a screen of ‘16:9’ according to an exemplary embodiment;

FIG. 20 illustrates an example of applying down-scaling in a horizontal direction when content having a format of ‘21:9’ is displayed on a screen of ‘16:9’ according to an exemplary embodiment;

FIG. 21 illustrates an example of a UI for setting display of an image, through which options for displaying an image on screens of various sizes are selectable according to an exemplary embodiment; and

FIG. 22 is a block diagram of a wireless communication apparatus according to an exemplary embodiment.

### DETAILED DESCRIPTION OF EXEMPLARY EMBODIMENTS

Below, exemplary embodiments will be described in detail with reference to accompanying drawings. The present disclosure may be achieved in various forms and not limited to the following embodiments. For convenience of description, parts not directly related to the present disclosure are omitted, and like numerals refer to like elements throughout.

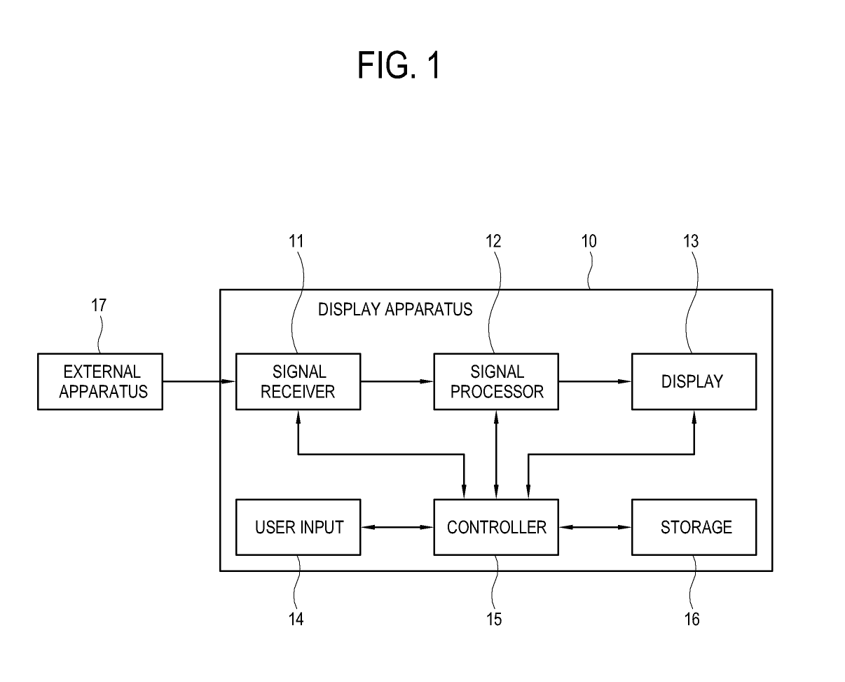

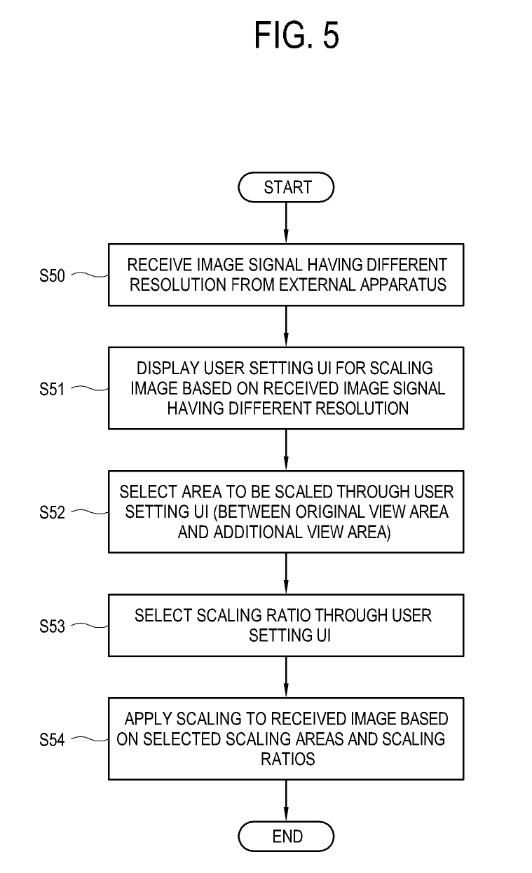

First, elements included in a display apparatus according to an exemplary embodiment will be described in detail with reference to FIG. 1, and FIGS. 5 to 21 will be also referred to as necessary. FIG. 1 is a block diagram of a display apparatus according to an exemplary embodiment. As shown in FIG. 1, a display apparatus 10 according to this exemplary embodiment includes a signal receiver 11, a signal processor 12, a display 13, a user input 14, a controller 15 and a storage 16, and may for example be achieved by a smart TV, a smart phone, a tablet computer, a personal computer (PC), a netbook, a notebook computer, etc. The display apparatus 10 is capable of communicating with an external apparatus 17 through a network. Further, the external apparatus 17 may be for example achieved by the PC, a digital versatile disc (DVD) player, an Internet server, etc. The display apparatus 10 according to this exemplary embodiment may further include additional other elements without being limited to the foregoing elements according to this embodiment.

The display apparatus 10 receives an image signal having a predetermined resolution from the external apparatus 17. The display apparatus 10 may make a request for an image signal having a different resolution from the receiving image signal to the external apparatus. The display apparatus 10 receives an image signal having a different resolution from the external apparatus 17, adjusts an image size of the received image signal having the different resolution in accordance with a screen size of the display 13, and displays the image having the adjusted size on a screen.

According to an exemplary embodiment, the display apparatus 10 receives an image signal different in resolution from the received image signal from the external apparatus in response to a user's request and displays an image having a size desired by him/her, thereby improving his/her field of view (FOV). Further, the display apparatus 10 according to an exemplary embodiment is advantageously capable of displaying an image even though the resolution of the image received from the external apparatus is different from the resolution supportable by the display apparatus.

The signal receiver 11 receives an image signal having a predetermined resolution from the external apparatus 17. The signal receiver 11 may be variously achieved in accordance with formats of a receiving broadcast signal and the types of the display apparatus 10. For example, the signal receiver 11 may include a tuner for receiving a radio frequency (RF) broadcast signal from a broadcasting station or a satellite signal. Alternatively, the signal receiver 11 may receive an image signal from the external apparatus 17, e.g., a PC, a DVD player, etc. connected to the display apparatus 10. Like this, the signal receiver 11 is not limited to this exemplary embodiment, but may be variously achieved as long as it can receive a broadcast signal.

According to an exemplary embodiment, the image signal received from the external apparatus 17 may for example include image signals corresponding to a game image, a sport image, a broadcast image, a DVD image, etc. Besides, the image signal may include various image signals that can be received in the display apparatus 10.

The signal processor 12 performs a plurality of signal processes with regard to an image signal received in the signal receiver 11. The plurality of signal processes may apply noise canceling, forward error correction (FECT), ATV/DTV AGC speed changing, equalizer slope change, Pilot size changing, symbol rate sensing range changing, phase tracking loop gain, frequency changing, and the like process to an image signal, without limitation.

The display 13 has a screen on which an image based on an image signal processed by the signal processor 12 is displayed. The display 13 may be achieved by a plasma display panel (PDP), a liquid crystal display (LCD), an organic light emitting diode (OLED), a flexible display, etc. without limitation.

The user input 14 receives a user's input. For example, the user input 14 may be achieved by a keyboard, a mouse, etc. or by an input panel provided on the outside of the display apparatus 10. According to an exemplary embodiment, the user input 14 may receive a user's input through a remote controller. A user's input may include at least one of selection of a (user interface) UI menu, input of a shortcut key, voice, motion, etc.

The storage 16 stores information about resolutions supportable by the display apparatus 10 in a memory area to which the external apparatus 17 can have access for transmitting an image signal. According to an exemplary embodiment, the storage 16 may include an extended display identification data (EDID) table where information about the display apparatus 10 is stored. In the EDID table, information about the plurality of resolutions supportable by the display apparatus 10 and basic display variables and characteristics are tabulated. Further, the EDID table complies with Video Electronics Standards Association (VESA) standards for imaging devices and multimedia apparatuses.

The controller 15 makes a request for an image signal different in resolution from an image signal, which is being received from the external apparatus 17, to the external apparatus 17. According to an exemplary embodiment, the controller 15 may make this request in response to a user's input. The controller 15 may make a request for information about transmittable resolutions to the external apparatus 17, and control the display 13 to display a UI showing the information about the transmittable resolutions received from the external apparatus 17. In this regard, the controller 15 selects one of the transmittable resolutions in response to a user's input through the UI, and makes a request for an image signal having the selected resolution to the external apparatus 17.

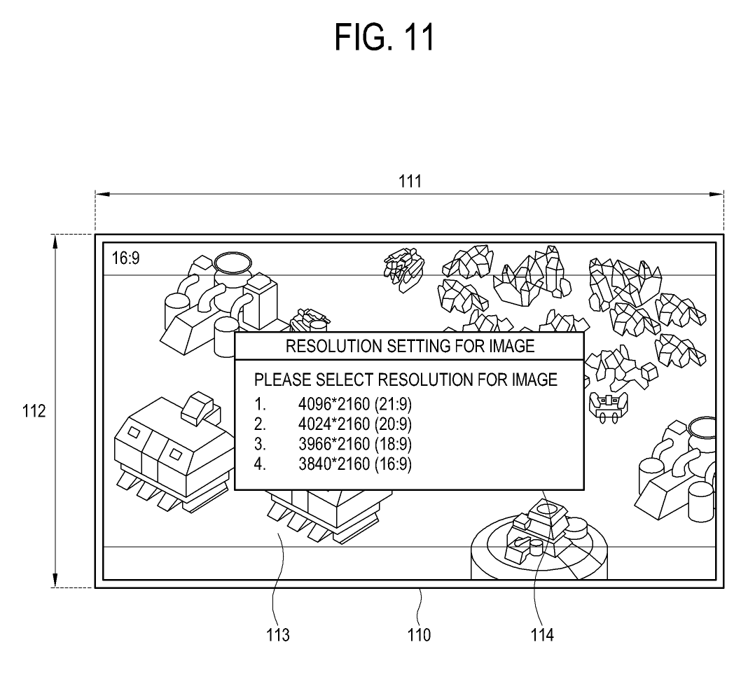

For instance, as shown in FIG. 11, while a display apparatus 110 displays a game image 113 on a screen having an aspect ratio of ‘16:9’ (i.e. a ratio of a width 111 to a height 112), a user may set the resolution of the image through a resolution setting UI 114 in order to view an image having a resolution higher than the resolution of resolution of ‘16:9’. At this time, the resolution setting UI 114 shows resolution information of the game image 113, which can be transmitted from the external apparatus 17. For example, the resolution setting UI 114 may show a list of resolutions not higher than the real resolution of the game image 113 provided by the external apparatus 17 and not lower than the resolution supportable in the display apparatus 10. That is, if the real resolution of the game image 113 is ‘4096*2160(21:9)’, the resolution setting UI 114 shows a list of resolutions equal to or higher than the resolution ‘3840*2160(16:9)’ of the display apparatus 110 and equal to lower than the resolution ‘4096*2160(21:9)’ so that a user can select one of the resolutions. Thus, a user can change the resolution of the image being displayed so as to view a cut-away area of the image.

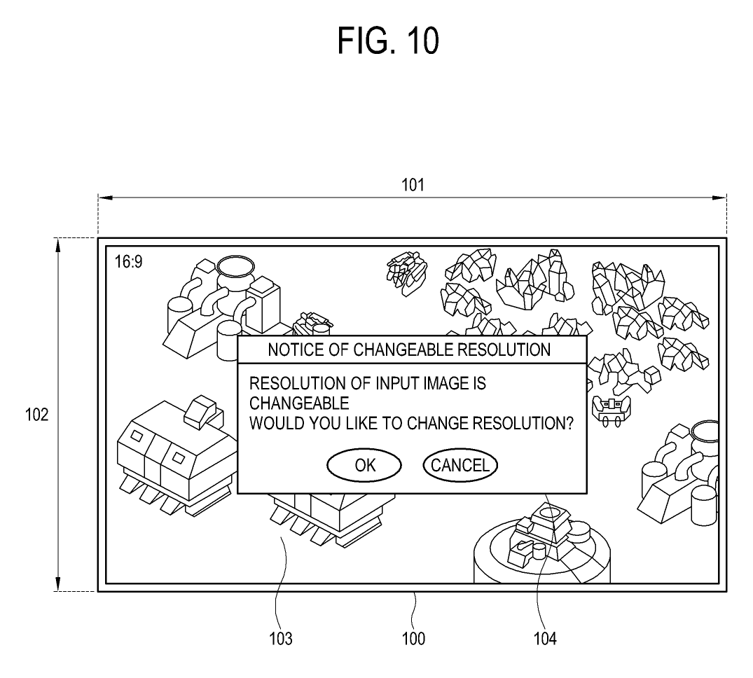

Alternatively, as shown in FIG. 10, the display apparatus 100 may display a UI 104 for informing a user that a resolution of a game image 103 received from the external apparatus 17 is changeable. If there are supportable resolutions different from the resolution of the game image 103 being displayed on the screen even though a user does not directly select a menu for setting a resolution, a user may be automatically informed of the supportable resolutions through the UI 104. At this time, if a user select ‘OK’ on the UI 104, the resolution setting UI 114 for changing the resolution of the game image 103 being currently displayed is displayed as shown in FIG. 11. Thus, a user can be informed that the resolutions different from the resolution of the image being displayed are supportable, and view an image having an optimum resolution.

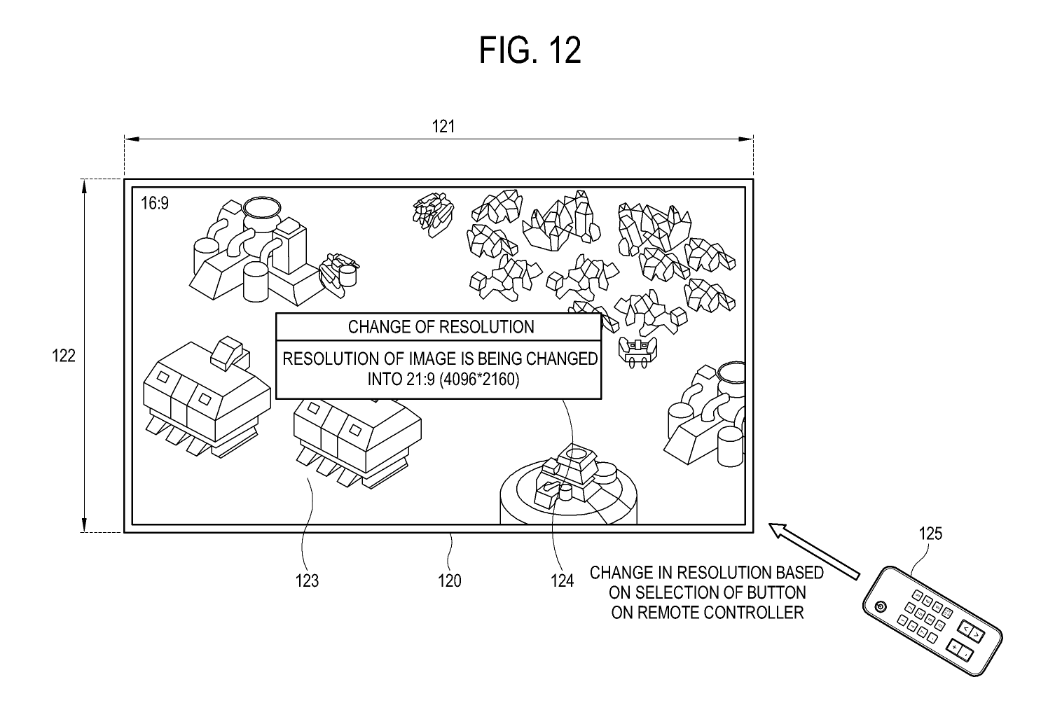

According to an exemplary embodiment, the controller may receive a user's input including at least one of selection of a UI menu, input of a shortcut key, voice and motion in order to make a request for an image signal having a different resolution to the external apparatus 17. For instance, as shown in FIG. 12, the display apparatus 120 may change a resolution of a game image 123 from ‘3840*2160(16:9)’ to ‘4096*2160(21:9)’ in response to a certain button selected on a remote controller 125. At this time, a UI 124 of informing that the resolution of the game image 123 is changed into ‘4096*2160(21:9)’ may be displayed, or the resolution of the game image 123 may be directly changed without displaying the UI 124. Alternatively, if a user's input is received through a keyboard, a resolution of a displayed image may be changed by pressing a shortcut key on the keyboard.

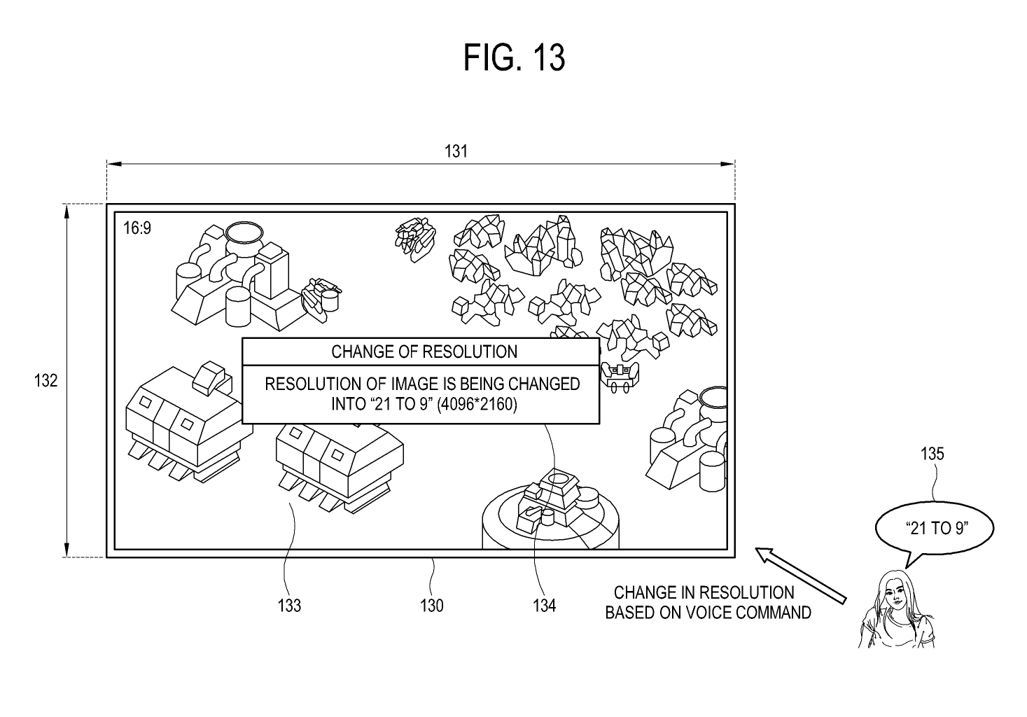

According to an exemplary embodiment, as shown in FIG. 13, a display apparatus 130 may change a resolution of a game image 133 in response to a user's voice command. If a user utters “21 to 9” 135, the display apparatus 130 recognizes a user's voice and determines the voice of “21 to 9” 135 as a command for change into a resolution of ‘21:9’ in accordance with results of the voice recognition. Thus, a user can change the resolution of the game image 133 through a simple voice command without finding and executing a menu for setting the resolution.

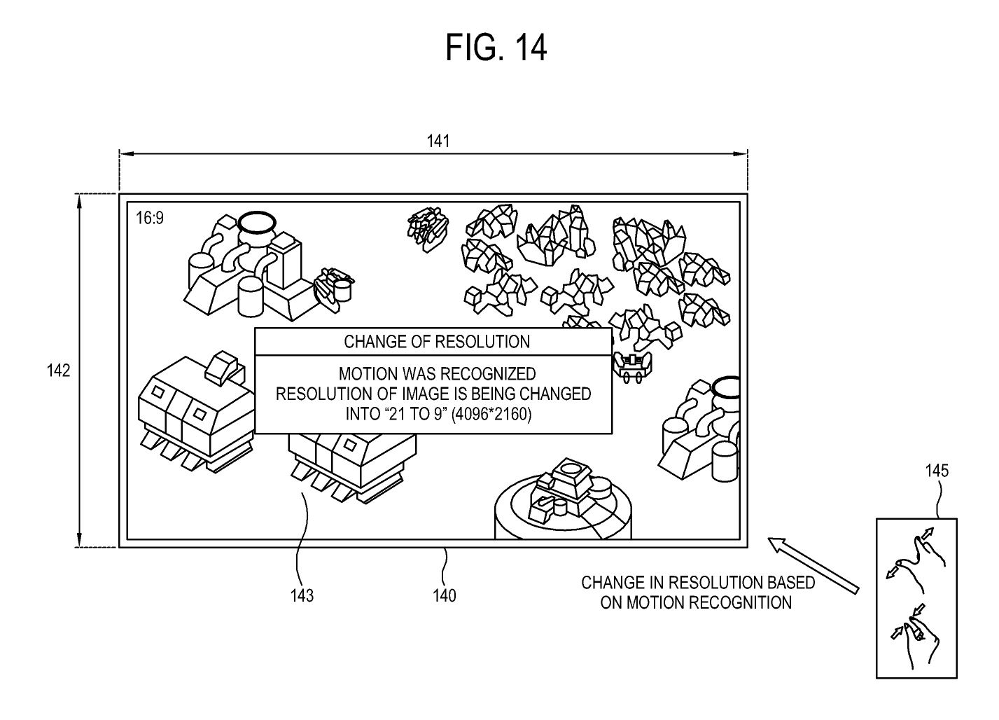

According to an alternative embodiment, as shown in FIG. 14, a display apparatus 140 may change a resolution of a game image 143 in response to recognition of a user's motion. If a user makes a motion 145 for enlargement or reduction with his/her thumb and finger, the display apparatus 140 recognizes a user's motion and determines the enlargement motion as a command for increasing the resolution or the reduction motion as a command for decreasing the resolution in accordance with results of the motion recognition. Thus, a user can change the resolution through a simple motion with his/her thumb and finger without additional operations for changing the resolution. Further, a user's motion for changing the resolution of the displayed image is not limited to the motion with the thumb and finger but may include a motion with his/her hands, his/her arms, a motion with the remote controller, etc.

The controller 15 performs control to receive an image signal different in resolution from an image being currently displayed from the external apparatus 17. At this time, the controller 15 may change the information stored in the storage 16 so as to correspond to the different resolution. According to an exemplary embodiment, the controller 15 may change the existing resolution information stored in the EDID table into different resolution information or add information about the different resolution to the existing resolution information, thereby receiving an image signal corresponding to the different resolution from the external apparatus 17. At this time, the controller 15 may receive an image signal corresponding to different resolution based on the changed or added EDID information.

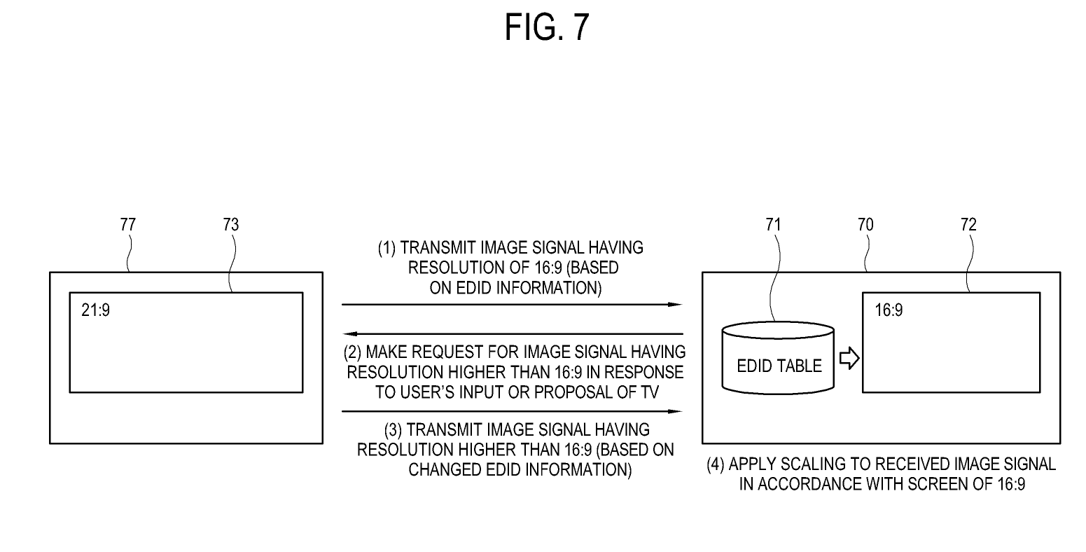

According to an exemplary embodiment, as shown in FIG. 7, if a PC 77 transmits an image signal for an image 73 having a resolution of ‘21:9’ to a TV 70, the TV 70 may receive an image signal having a resolution of ‘16:9’ supportable in a screen 72 of the TV 70 based on EDID information previously stored in an EDID table 71. At this time, the resolution of ‘16:9’ supported by the TV 70 is different from the resolution of ‘21:9’ for the image 73 received from the PC 77, and therefore the TV 70 cannot display the image 73 received from the PC 77 on a screen 72 or display the image 73 as if left and right partial areas of the image 73 are cut away. In this case, the TV 70 may make a request for an image signal, which has a resolution higher than its own resolution of ‘16:9’, to the PC 77 in response to a user's command. At this time, the resolution of ‘16:9’ previously stored in the EDID table 71 may be changed into the resolution of ‘21:9’, or the resolution of ‘21:9’ may be added to the EDID table 71. In response to the request of the TV 70, the PC 77 transmits the image signal corresponding to the resolution of ‘21:9’ to the TV 70 based on the EDID information of the changed EDID table 71 so as to be displayed on the screen 72 of the TV 70.

According to an exemplary embodiment, the controller may make a request for an image signal different in an aspect ratio from a received image signal to the external apparatus 17, and receive the image signal having the different aspect ratio from the external apparatus 17. For instance, if an image signal received from the external apparatus 17 has an aspect ratio of ‘16:9’, the controller 15 may make a request for an image signal having an aspect ratio of ‘21:9’ to the external apparatus 17 in response to a user's request or a proposal of the display apparatus 10. That is, the controller 15 may make a request for an image signal, which is different in not the resolution but the aspect ratio from an image signal being currently received, to the external apparatus 17, thereby receiving and displaying an image signal having a different aspect ratio from the aspect ratio of the currently received image signal.

According to an exemplary embodiment, the signal processor 12 may include a scaler for scaling an image based on an image signal having a different resolution with respect to at least one of horizontal and vertical directions. The controller 15 may display a user setting UI for allowing a user to set a scaling area and a scaling ratio for an image based on an image signal having a different resolution, and applies scaling to an image based on an image signal received in response to a user's input through the displayed UI and having the different resolution.

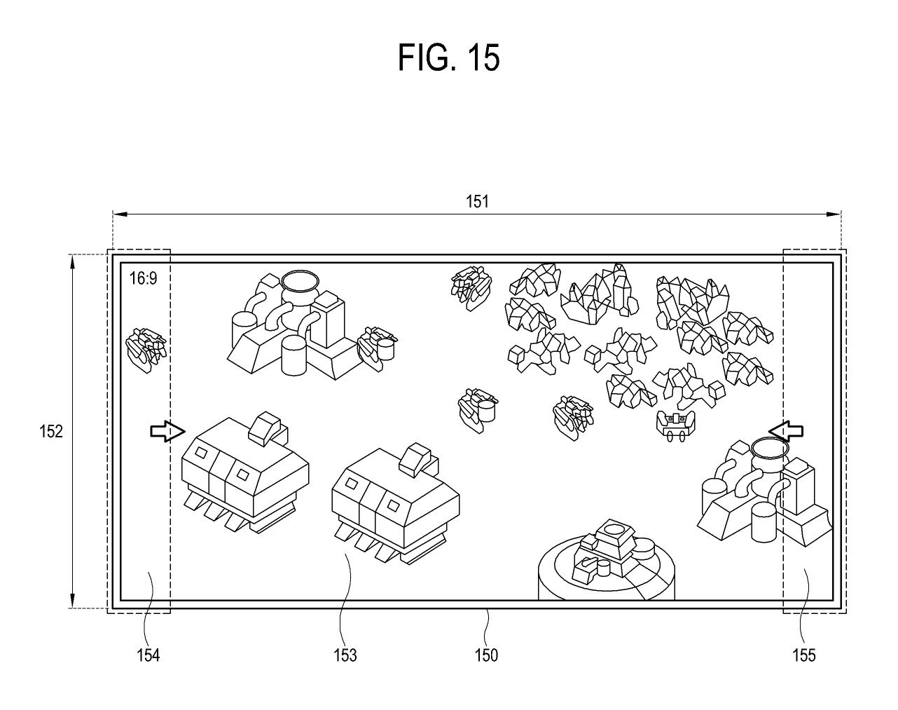

According to an exemplary embodiment, the controller 15 may display an original view area corresponding to an image signal, which has been being received having a predetermined resolution, and an additional view area added to the original view area as an image signal is received having a different resolution, when the image subject to the scaling is displayed. Here, the original view area is a view area displayed based on the EDID information previously stored in the storage 16, and the additional view area is a view area additionally displayed based on EDID information changed corresponding to a different resolution requested from the external apparatus 17. The controller 15 may respectively apply different scaling ratios to the original view area and the additional view area. For instance, as shown in FIG. 15, a display apparatus 150 may display an original view area 153 corresponding to a game image having a resolution of ‘16:9’ supportable by the display apparatus 150, and a left additional view area 154 and a right additional view area 155 added as a game image having a resolution of ‘21:9’ is received, when the game image having the resolution of ‘21:9’ received from the external apparatus is displayed on a screen having a ratio of a width 151 to a height 152, i.e. an aspect ratio of ‘16:9’. That is, the original view area 153 refers to an image displayed based on the previously stored EDID information, and the left additional view area 154 and the right additional view area 155 refer to images displayed based on EDID information changed to receive an image having a resolution of ‘21:9’ and added to the original view area 153.

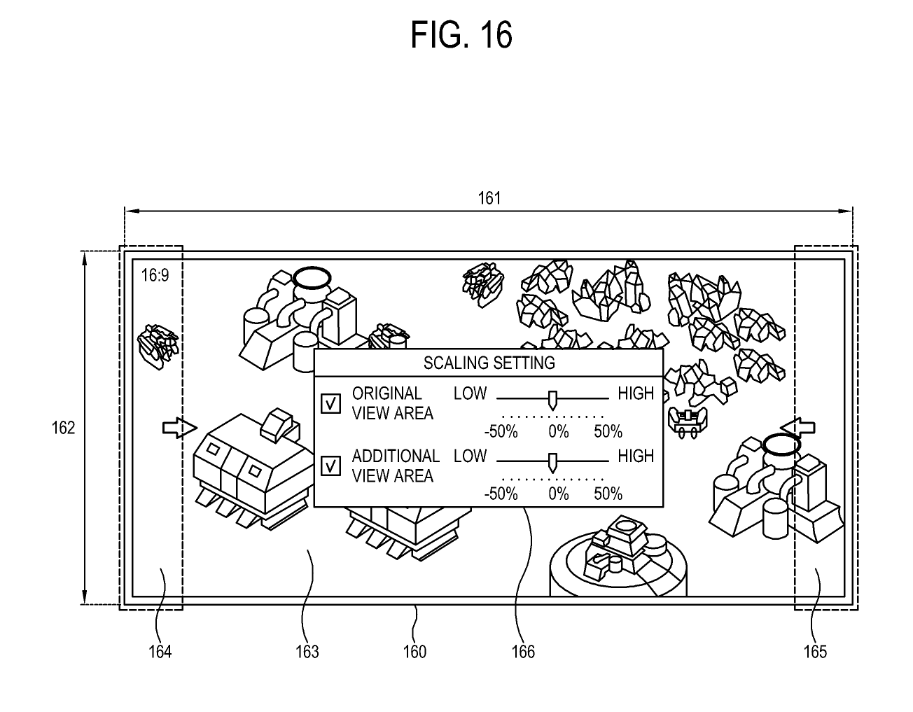

According to an exemplary embodiment, as shown in FIG. 16, a display apparatus 160 may adjust the size of game image so that the game image having the resolution of ‘21:9’ received from the external apparatus can be displayed on the screen having a ratio of a width 161 to a height 162, i.e. an aspect ratio of ‘16:9’. At this time, different scaling ratios may be respectively applied to an original view area 163 and additional view areas 164 and 165 of the game image. For instance, a user setting UI 166 for scaling is displayed, and at least one area to be subjected to the scaling is selected among the original view area 163 and the additional view areas 164 and 165 through the displayed UI 166. Then, it is possible to set a ratio of enlarging or reducing the selected area. Here, the ratio of enlarging or reducing the selected area may be set between ‘−50%’ and ‘50%,’ but not limited thereto. Alternatively, the ratio may be set within variously ranges.

According to an exemplary embodiment, if an image signal is newly received having a higher resolution than an image signal, which has been being received, from the external apparatus 17, the controller 15 may apply down-scaling to an image based on the image signal having the higher resolution in accordance with the screen size of the display 13. Further, if an image signal is newly received having a lower resolution than an image signal, which has been being received, from the external apparatus 17, the controller 15 may apply up-scaling to an image based on the image signal having the lower resolution in accordance with the screen size of the display 13. For instance, if the TV has a resolution or ‘3840*2160(16:9)’ and a newly received image has a resolution of ‘4096*2160(21:9)’, the image may be subject to the down-scaling so as to be reduced in size and thus fully displayed on the screen. On the other hand, if the TV has a resolution of ‘4096*2160(21:9)’ and a newly received image has a resolution of ‘3840*2160(16:9)’, the image may be subjected to the up-scaling so as to be enlarged in sized and thus fully displayed on the screen without any margin.

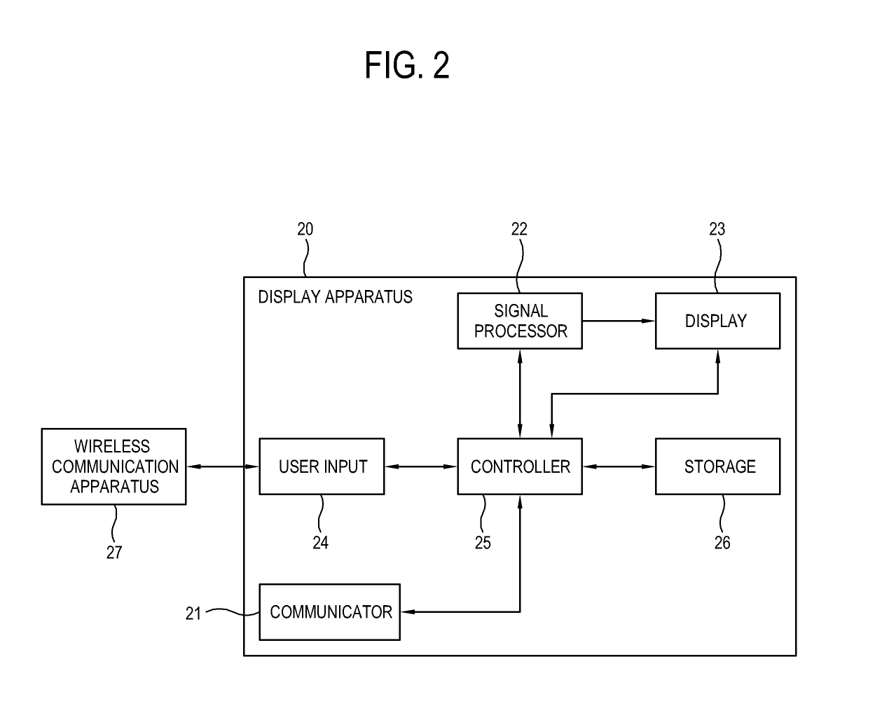

FIG. 2 is a block diagram of a display apparatus according to an exemplary embodiment. As shown in FIG. 2, a display apparatus 20 according to an exemplary embodiment includes a communicator 21, a signal processor 22, a display 23, a user input 24, a controller 25 and a storage 26, and may for example be achieved by a smart TV, a smart phone, a tablet computer, a personal computer (PC), a netbook, a notebook computer, etc. Further, the display apparatus 20 according to this exemplary embodiment wirelessly communicates with a wireless communication apparatus 27 through wireless communication standards, e.g. wireless fidelity (Wi-Fi), Bluetooth, etc. The wireless communication apparatus 27 may for example be achieved by a smart phone, a tablet computer, a smart TV, etc. The display apparatus 20 according to this exemplary embodiment may further include additional other elements without being limited to the foregoing elements according to this embodiment.

Among the foregoing elements of the display apparatus 20, the signal processor 22, the display 23, the user input 24, the controller 25 and the storage 26 respectively correspond to the signal processor 12, the display 13, the user input 14, the controller 15 and the storage 16 of FIG. 1, and therefore repetitive descriptions thereof will be avoided. In other words, only different configurations and elements will be described below.

The communicator 21 wirelessly communicates with a wireless communication apparatus 27. For instance, the communicator 21 may connect with the wireless communication apparatus 27 by Wi-Fi, Bluetooth or the like communication method. If the communicator 21 connects with the wireless communication apparatus 27, the display apparatus 20 can exchange data with the wireless communication apparatus 27 through the communicator 21.

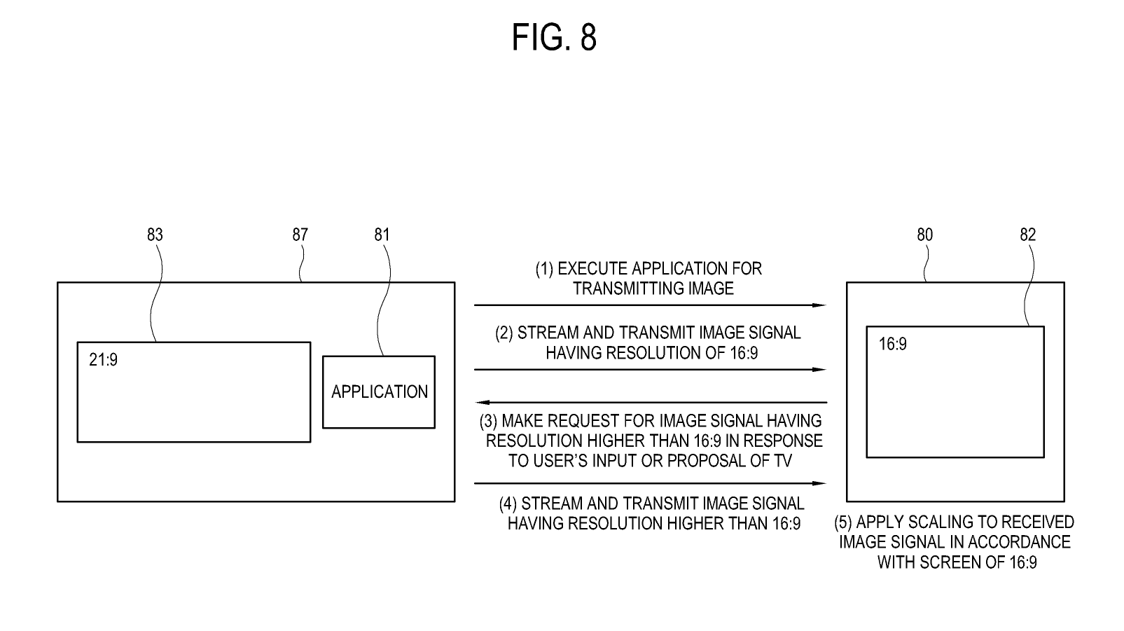

The controller 25 controls the communicator 21 to stream an image signal having a predetermined resolution from the wireless communication apparatus 27. The controller 25 makes a request for an image signal different in resolution from the streaming image signal to the wireless communication apparatus 27. The controller 25 streams the image signal having the different resolution from the wireless communication apparatus 27. For instance, as shown in FIG. 8, a smart phone 87 executes an application 81 to transmit a streaming image signal for an image 83 having a resolution of ‘21:9’ to a TV 80. At this time, the TV 80 may receive a streaming image signal having a resolution of ‘16:9’ supportable on its screen 82 through the stored resolution information. If the resolution of ‘16:9’ supportable by the TV 80 is different from the resolution of ‘21:9’ of the image 83 received from the smart phone 87, the TV 80 cannot display the image 83 streamed from the smart phone 87 on the screen 82 or displays the streamed image 83 as if right and left areas thereof are partially cut away. In this case, in order to display the full area of the image 83 on the screen 82 of the TV 80 in response to a user's command, the controller 25 may make a request for an image signal, which has a resolution higher than the resolution of ‘16:9’ of the TV 80, to the smart phone 87. In response to the request from the TV 80, the smart phone 87 transmits the streaming image signal having the resolution of ‘21:9’ to the TV 80 so as to be displayed on the screen 82 of the TV 80.

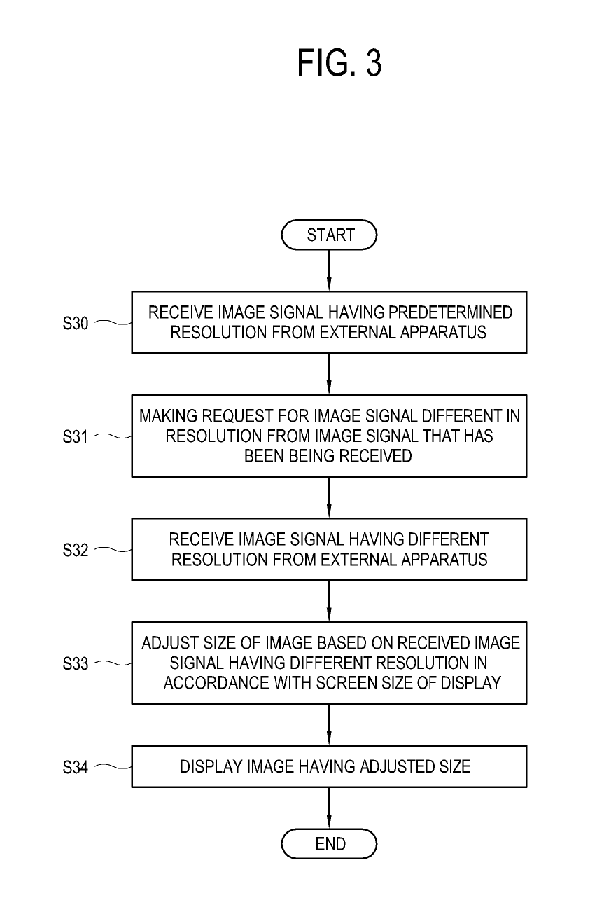

FIG. 3 is a flowchart showing a method of controlling a display apparatus according to an exemplary embodiment. As shown in FIG. 3, at operation S30, an image signal having a predetermined resolution is received from an external apparatus, and at operation S31, a request for an image signal different in resolution from the image signal being received is made to the external apparatus. Here, the operation S31 may include receiving a user's input, and making a request for an image signal having a different resolution to the external apparatus in response to a user's input. Further, a user's input may include at least one selection from a UI menu, input of a shortcut key, voice and motion.

According to an exemplary embodiment, the external apparatus may operate to store information about resolutions supportable in the display apparatus in a memory area to be accessed for transmitting an image signal and change the stored information in accordance with different resolutions.

According to an alternative embodiment, a request for information about transmittable resolutions may be made to the external apparatus, and a UI showing information about the transmittable resolutions received from the external apparatus may be displayed. At this time, one among the transmittable resolutions is selected in response to a user's input to the UI, and a request for an image signal having the selected resolution may be made to the external apparatus.

Next, at operation S32 the image signal having the different resolution is received from the external apparatus, and at operation S33 the size of the image based on the received image signal having the different resolution is adjusted corresponding to the screen size of the display. Here, the operation S33 may include applying the scaling to the image based on the received image signal having the different resolutions with respect to at least one of the horizontal and vertical directions. Further, the operation S33 may include displaying an original view area corresponding to the image signal, which has been being received having the predetermined resolution, and an additional view area corresponding to the image signal, which is newly received having the different resolution, and added to the original view area. At this time, the operation S33 may include applying the different scaling ratios to the original view area and the additional view area, respectively.

According to an exemplary embodiment, if an image signal having a higher resolution than the image signal being received is newly received from the external apparatus, the image based on the image signal having the higher resolution is subject to the down-scaling in accordance with the screen size of the display. On the other hand, if an image signal having a lower resolution than the image signal being received is newly received from the external apparatus, the image based on the image signal having the higher resolution is subject to the up-scaling in accordance with the screen size of the display.

According to an exemplary embodiment, a request for an image signal different in an aspect ratio from the image signal being received may be made to the external apparatus, and the image signal having the different aspect ratio may be received from the external apparatus. That is, a request for an image signal different in not the resolution but the aspect ratio from the image signal being received is made to the external apparatus, and the image signal having the different aspect ratio is received and displayed.

Lastly, at operation S34, the image adjusted in size is displayed. Thus, the display apparatus receives an image signal different in resolution from the receiving image signal from the external apparatus in response to a user's request and thus displays an image, the size of which is adjusted as desired by him/her, thereby having an effect on improving a user's view area. Further, it is advantageous to receive and display an image even when the resolution of the image provided by the external apparatus is different from the resolutions supportable by the display apparatus.

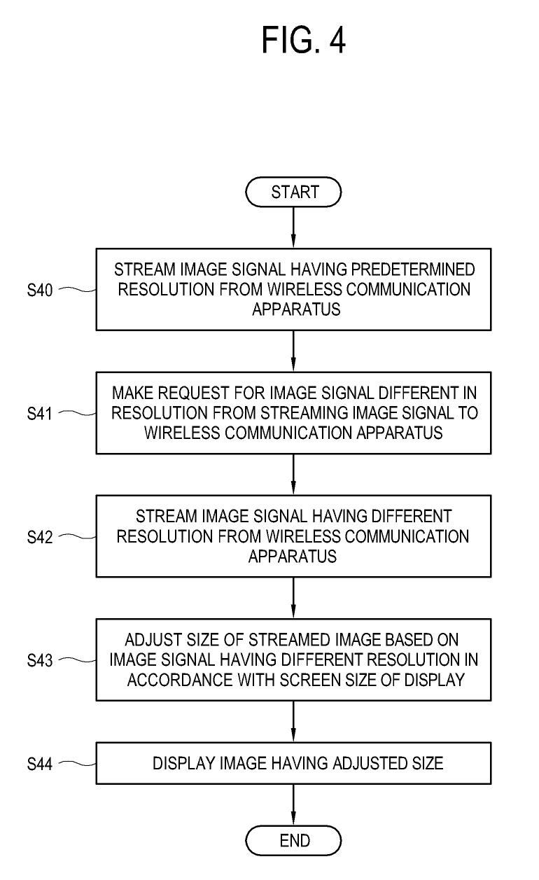

FIG. 4 is a flowchart showing a method of controlling a display apparatus according to an exemplary embodiment. As shown in FIG. 4, at operation S40 an image signal having a predetermined resolution is streamed from a wireless communication apparatus. Next, at operation S41, a request for an image signal different in resolution from the streaming image signal is made to the wireless communication apparatus, and at operation S42 an image signal having a different resolution is streamed from the wireless communication apparatus. Next, at operation S43, the size of the image based on the streamed image signal having the different resolution is adjusted corresponding to the screen size of the display. Lastly, at operation S44, the image having the adjusted size is displayed.

FIG. 5 is a flowchart showing a scaling process with regard to a received image having a different resolution according to an exemplary embodiment. As shown in FIG. 5, at operation S50, an image signal having a different resolution is received from an external apparatus. Next, at operation S51 a user setting UI for applying scaling to the image based on the received image signal having the different resolution, and at operation S52 scaling areas are selected through the user setting UI. Here, the scaling areas may include an original view area corresponding to the resolution of the image signal being received, and additional view areas added to the original view areas as the image signal having the different resolution is received.

Next, at operation S53, scaling ratios are selected through a user setting UI. At this time, the respective scaling ratios may be differently applied to the original view area and the additional view areas. For instance, as shown in FIG. 16, in order to differently apply the scaling ratios to the original view area 163 and additional view areas 164 and 165 of a game image, ratios for enlarging or reducing the original view area 163 and the additional view areas 164 and 165 may be respectively set through the user setting UI 166.

Lastly, at operation S54, the received image is subject to the scaling with regard to the selected scaling areas and the set scaling ratios. Thus, the display apparatus according to this exemplary embodiment respectively applies different scaling ratios to the different areas of the image in accordance with a user's setting when the image to be displayed on the screen is subject to the scaling, thereby controlling the amount of information obtained from the different areas of the image.

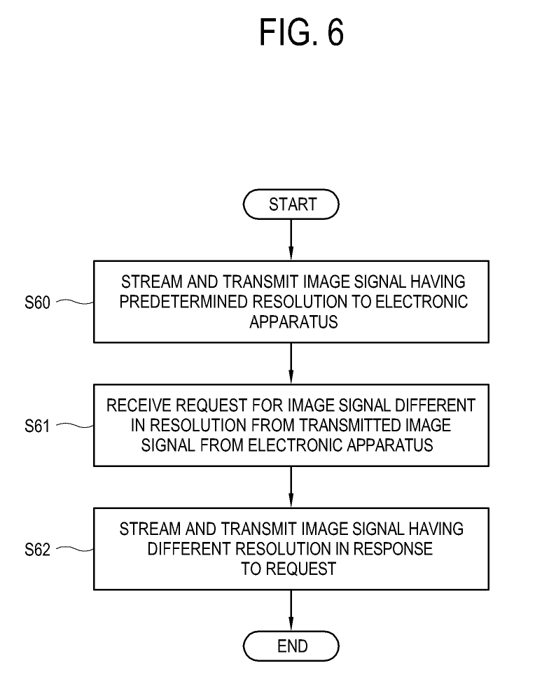

FIG. 6 is a flowchart showing a control method of the wireless communication apparatus according to an exemplary embodiment. As shown in FIG. 6, at operation S60, an image signal having a predetermined resolution is streamed and transmitted to the electronic apparatus. Here, the operation S60 may include executing an application for streaming and transmitting an image signal having a predetermined resolution to the electronic apparatus in response to a user's input.

Next, at operation S61, the wireless communication apparatus receives a request for an image signal, which is different in resolution from the image signal being transmitted, from the electronic apparatus. Here, in response to the request, the wireless communication apparatus changes the resolution of the image signal into the different resolution or determine presence of a file corresponding to the image signal having the different resolution.

Lastly, at operation S62, the wireless communication apparatus streams and transmits the image signal having the different resolution to the electronic apparatus in response to the request.

FIG. 7 illustrates a process that a TV receives an image having a different resolution from a PC by changing EDID information according to an exemplary embodiment. As shown in FIG. 7, if the PC 77 transmits an image signal for the image having a resolution of ‘21:9’ to the TV 70, the TV 70 checks EDID information previously stored in the EDID table 71 and thus determines whether the transmitted image 73 of ‘21:9’ is displayable on the screen. At this time, the previously stored EDID information is resolution information supportable in the TV 70, and thus the TV 70 can receives an image signal having a supportable resolution of ‘16:9’.

At this time, the resolution of ‘16:9’ supportable in the TV 70 is different from the resolution of ‘21:9’ of the image 73 transmitted from the PC 77, and therefore the TV 70 cannot display the image received from the PC 77 on the screen or displays the image 73 as if the left and right areas thereof are cut away. In this case, the TV 70 may make a request for an image signal having a resolution higher than the resolution of ‘16:9’ of the TV 70 to the PC 77 in order to fully display the image 73 on the screen 72. At this time, the resolution of ‘16:9’ previously stored in the EDID table 71 may be changed into the resolution of ‘21:9’, or the resolution of ‘21:9’ may be added. In response to the request from the TV 70, the PC 77 transmits the image signal having the resolution of ‘21:9’ to the TV 70 based on the changed EDID information of the EDID table 71 so that the TV 70 can receive the image signal.

FIG. 8 illustrates a process that a TV receives a stream of an image having a different resolution from a smart phone according to an exemplary embodiment. As shown in FIG. 8, the smart phone 87 executes the application 81 to stream and transmit an image signal for the image 83 having a resolution of ‘21:9’ to the TV 80. At this time, the TV 80 receives a streaming image signal having a resolution of ‘16:9’ supportable in the screen 82 of the TV 80 based on the previously stored resolution information. Since the resolution of ‘16:9’ supportable in the TV 80 is different from the resolution of ‘21:9’ of the image 83 transmitted from the smart phone 87, the TV 80 cannot display the image 83 streamed from the smart phone 87 on the screen 82 or displays the streaming image 83 as if right and left areas thereof are cut away. In this case, the TV 80 may make a request for an image signal, which has a resolution higher than the resolution of ‘16:9’ of the TV 80, to the smart phone 87, in order to display the full area of the image 83 on the screen 82 of the TV 80 in response to a user's command. In response to the request from the TV 80, the smart phone 87 transmits a streaming image signal having the resolution of ‘21:9’ to the TV 80 so that the TV 80 can receive the image signal.

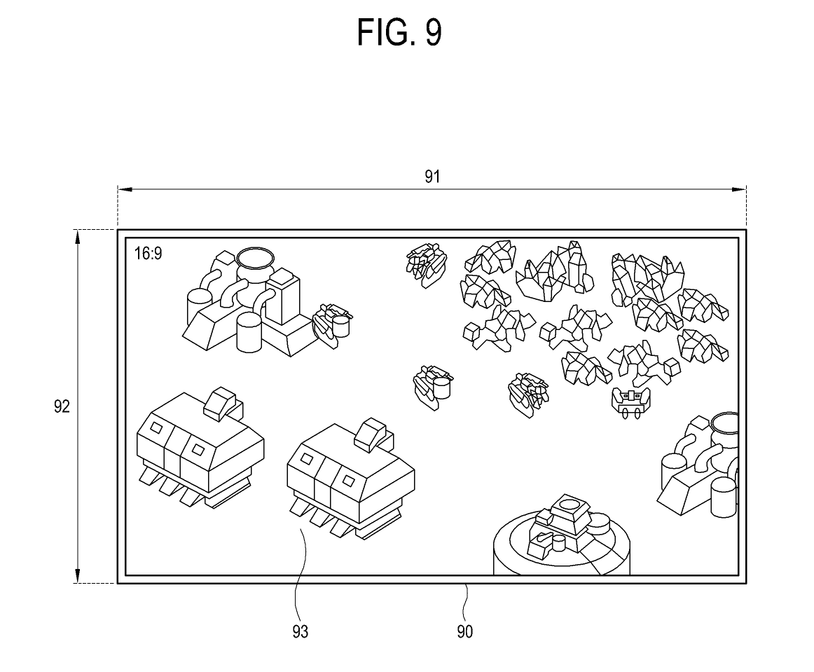

FIG. 9 illustrates an example of displaying an image having a resolution supported in a TV according to an exemplary embodiment. As shown in FIG. 9, when a display apparatus 90 displays a game image having a resolution of ‘21:9’ received from an external apparatus on a screen having a ratio of a width 91 to a height 92, i.e. an aspect ratio of ‘16:9’, a game image 93 may be displayed to have the resolution of ‘16:9’ supportable in the display apparatus 90. At this time, it is checked through the EDID information previously stored in the display apparatus 90 whether the currently supportable resolution is ‘16:9’, and thus the game image 93 is displayed by the resolution of ‘16:9’. In this case, if the game image 93 having the resolution of ‘21:9’ is displayed on the screen having the resolution of ‘16:9’, the game image 93 may be displayed as if the left and right areas thereof are cut away from the full area of the game image 93. Accordingly, it is inconvenient for a user since she/he cannot obtain information from the left and right areas of the game image 93.

FIG. 10 illustrates an example of a UI for informing that a resolution of an image displayed on a TV is changeable according to an exemplary embodiment. As shown in FIG. 10, the display apparatus 100 may display a UI 104 for informing a user that the resolution of the game image 103 is changeable, while the game image 103 having the resolution of ‘21:9’ received from the external apparatus is being displayed on the screen having a ratio of a width 101 to a height 102, i.e. an aspect ratio of ‘16:9’. The display apparatus 100 determines that there are areas a user cannot view since the game image 103 having the resolution of ‘21:9’ is displayed on the screen having the resolution of ‘16:9’, and guides him/her to change the resolution in order to improve such a view area. That is, if a resolution different from the resolution of the game image 103 being displayed on the screen is supportable even though a user does not directly select a menu for setting the resolution, the UI 104 may be automatically displayed for informing a user of this supportable resolution. At this time, if a user selects ‘OK’ in the UI 104, a UI for setting the resolution is displayed so that she/he can change the resolution of the currently displayed game image 103. Thus, if there is a supportable resolution different from the resolution of the image being currently displayed, a user can be informed about the supportable resolution and change the current resolution into a desired resolution to thereby improve a view area.

FIG. 11 illustrates an example of a UI for setting a resolution, through which the resolution of the image displayed on the TV can be set according to an exemplary embodiment. As shown in FIG. 11, while the display apparatus 110 displays the game image 113 on the screen having a ratio of the width 111 to the height 112, i.e. an aspect ratio of ‘16:9’, a user may set the resolution of the image through the resolution setting UI 114 in order to view the image by a resolution higher than the resolution of ‘16:9’. At this time, the resolution setting UI 114 displays information about resolutions of the game image 113 transmittable from the external apparatus 17. For example, the resolution setting UI 114 shows a list of resolutions not higher than the real resolution of the game image 113 provided by the external apparatus 17 and not lower than the resolution supportable by the display apparatus 110. That is, if the real resolution of the game image 113 is ‘4096*2160(21:9)’, the resolution setting UI 114 shows a list of resolutions equal to or higher than the resolution ‘3840*2160(16:9)’ of the display apparatus 110 and equal to lower than the resolution ‘4096*2160(21:9)’ so that a user can select one of the resolutions. Thus, a user can change the resolution of the image being displayed and view a cut-away area of the image.

FIG. 12 illustrates an example of changing the resolution of the image displayed on the TV by a remote controller according to an exemplary embodiment. As shown in FIG. 12, the display apparatus 120 may change the resolution of the game image 123 from ‘3840*2160(16:9)’ to ‘4096*2160(21:9)’ in response to a certain button selected on the remote controller 125, while displaying the game image 123 on the screen having a ratio of a width 121 to a height 122, i.e. an aspect ratio of ‘16:9’. At this time, the UI 124 for informing that the resolution of the game image 123 is changed into ‘4096*2160(21:9)’ may be displayed, or the resolution of the game image 123 is directly changed and displayed without displaying the UI 124.

According to an alternative embodiment, if a user selects a preset button on the remote controller 125 after the game image 123 is displayed by changing its resolution into ‘4096*2160(21:9)’, the game image 123 may be returned to the previous resolution of ‘3840*2160(16:9)’.

FIG. 13 illustrates an example of changing the resolution of the image displayed on the TV by a user's voice command according to an exemplary embodiment. As shown in FIG. 13, the display apparatus 130 may change a resolution of a game image 133 being displayed in response to a user's voice command, while displaying the game image 133 on the screen having a ratio of a width 131 to a height 132, i.e. an aspect ratio of ‘16:9’. If a user utters “21 to 9” 135, the display apparatus 130 recognizes a user's voice and determines the voice of “21 to 9” 135 as a command for change into a resolution of ‘21:9’ in accordance with results of the voice recognition. Thus, a user can change the resolution of the game image 133 through a simple voice command without complicated steps of finding and executing a menu for setting the resolution.

FIG. 14 illustrates an example of changing the resolution of the image displayed on the TV by motion recognition according to an exemplary embodiment. As shown in FIG. 14, the display apparatus 140 may change a resolution of the game image 143 in response to recognition of a user's motion, while displaying the game image 143 on the screen having a ratio of a width 141 to a height 142, i.e. an aspect ratio of ‘16:9’. That is, if a user makes the motion 145 for enlargement or reduction with his/her thumb and finger, the display apparatus 140 recognizes a user's motion and determines the enlargement motion as a command for increasing the resolution or the reduction motion as a command for decreasing the resolution in accordance with results of the motion recognition. Thus, a user can change the resolution through a simple motion with his/her thumb and finger without additional operations for changing the resolution. Further, a user's motion for changing the resolution of the displayed image is not limited to the motion with the thumb and finger but may include a motion with his/her hands, his/her arms, a motion with the remote controller, etc.

FIG. 15 illustrates an example of an original view area corresponding to a resolution of an image, which has been received, and an additional view area corresponding to a different resolution of an image, which is being received, according to an exemplary embodiment. As shown in FIG. 15, the display apparatus 150 may display the original view area 153 corresponding to the game image having the resolution of ‘16:9’ supportable in the display apparatus 150, and the left additional view area 154 and the right additional view area 155 added as the game image having the resolution of ‘21:9’ is received, when the game image having the resolution of ‘21:9’ received from the external apparatus is displayed on the screen having the ratio of the width 151 to the height 152, i.e. an aspect ratio of ‘16:9’. Here, the original view area 153 refers to an image displayed based on the previously stored EDID information, and the left additional view area 154 and the right additional view area 155 refer to images displayed based on EDID information changed to receive an image having a resolution of ‘21:9’ and added to the original view area 153.

FIG. 16 illustrates an example of a UI for setting respective scaling ratios with regard to the original view area and the additional view area according to an exemplary embodiment. As shown in FIG. 16, the display apparatus 160 may adjust the size of a game image in order to display the game image having a resolution of ‘21:9’ received from the external apparatus on a screen having a ratio of the width 161 to the height 162, i.e. an aspect ratio of ‘16:9’. At this time, different scaling ratios may be respectively applied to the original view area 163 displayable by the resolution of ‘16:9’ originally supportable by the TV within the full area of the game image, and the additional view areas 164 and 165 additionally displayable as the game image having the resolution of ‘21:9’ higher than ‘16:9’ is received in response to the request from the TV. For instance, the user setting UI 166 for scaling is displayed, and at least one area to be subjected to the scaling is selected between the original view area 163 and the additional view areas 164 and 165 through the displayed UI 166. Then, it is possible to set a ratio of enlarging or reducing the selected area. Here, the ratio of enlarging or reducing the selected area may be set between ‘−50%’ and ‘50%,’ but not limited thereto. Alternatively, the ratio may be set within other various ranges.

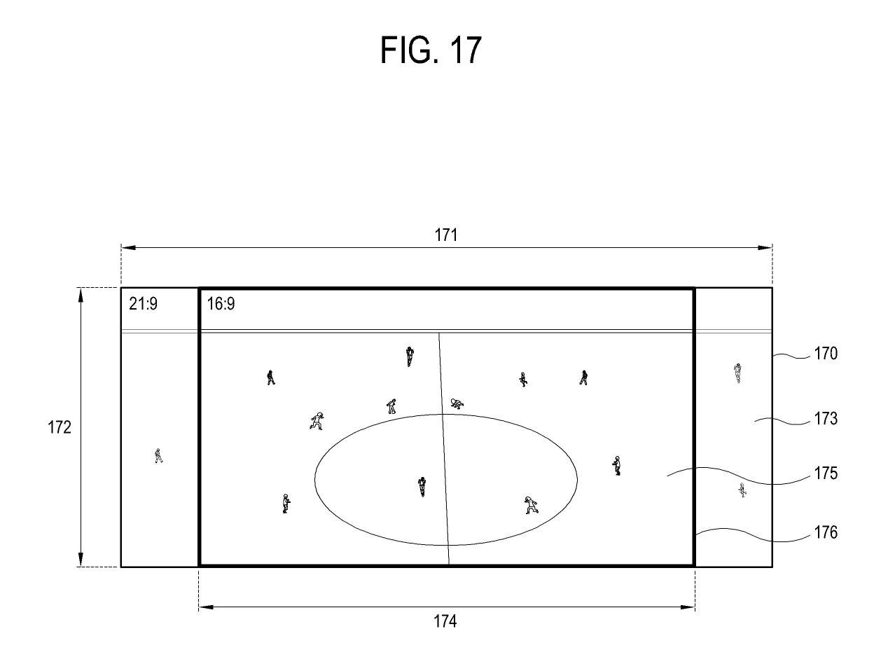

FIG. 17 illustrates an example of displaying content having a format of ‘21:9’ on a screen of ‘16:9’ and a screen of ‘21:9’ according to an exemplary embodiment. As shown in FIG. 17, if a sport image having a format of ‘21:9’ is displayed on a screen 176 having a ratio of a width 174 to a height 172, i.e. an aspect ratio of ‘16:9’ without being subjected to the scaling, the sport image having the format of ‘21:9’ is displayed as an image 175 of which left and right areas are cut away. On the other hand, if a sport image having a format of ‘21:9’ is displayed on a screen 170 having a ratio of a width 171 to the height 172, i.e. an aspect ratio of ‘21:9’ without being subjected to the scaling, the sport image having the format of ‘21:9’ is displayed as a full image 173 without cut-away areas. Like this, if the real format of the image is different from the screen size of the display apparatus, it is inconvenient for a user since partial areas of the image are cut away. Therefore, according to an exemplary embodiment, even if the real format of the image is different from the screen size of the display apparatus, the image signal having the real format is received and adjusted to correspond to the screen size so that a user can view the full area of the image.

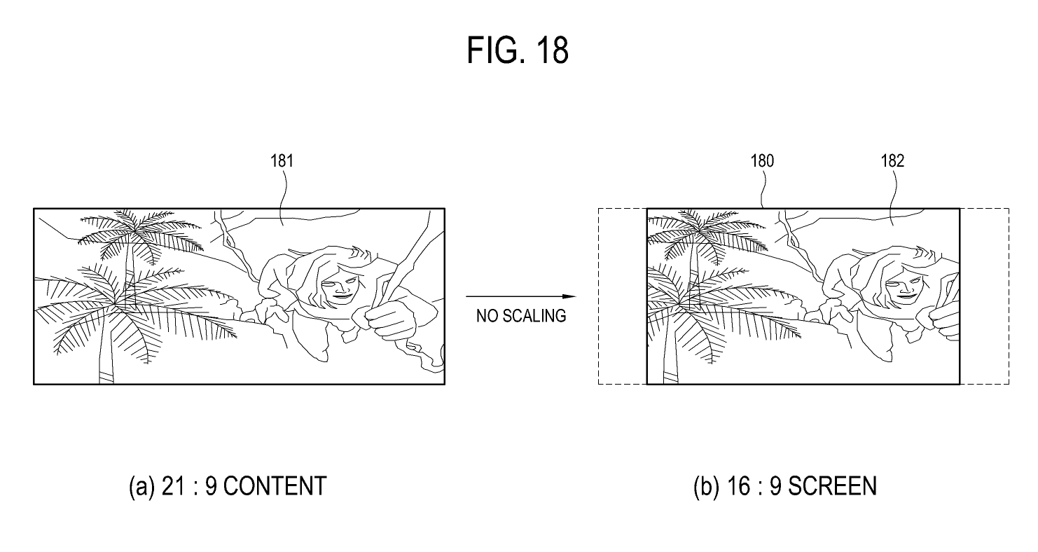

FIG. 18 illustrates an example of applying no scaling when content having a format of ‘21:9’ is displayed on a screen of ‘16:9’ according to an exemplary embodiment. As shown in FIG. 18, if scaling is not applied when a content image 181 having a format of ‘21:9’ is displayed on a screen of ‘16:9’ of the display apparatus 180, the content image 181 having the format of ‘21:9’ is not fully displayed on the screen but displayed as an image 182, of which left and right areas are cut away, on the screen.

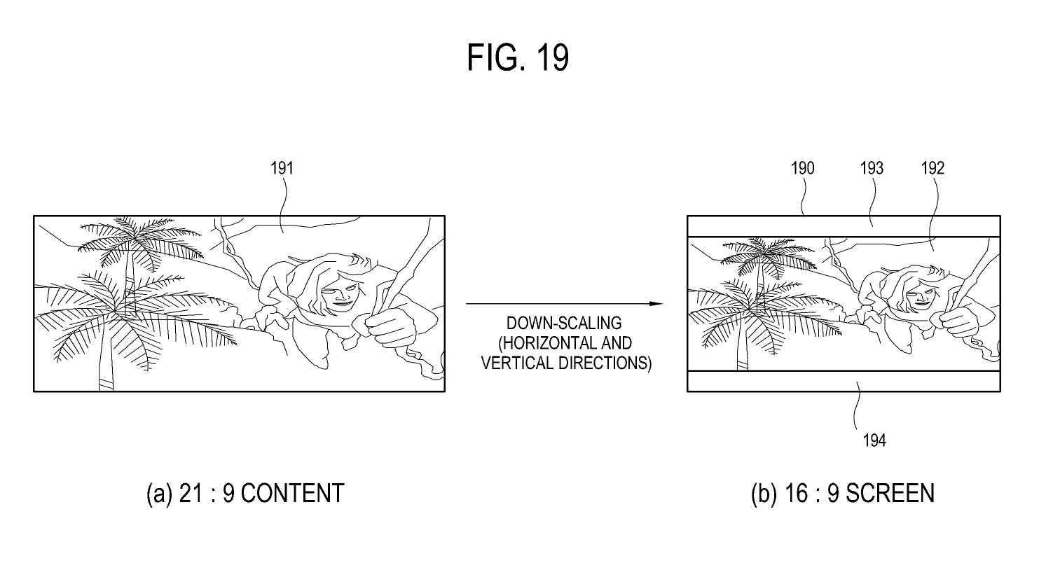

FIG. 19 illustrates an example of applying down-scaling in horizontal and vertical directions when content having a format of ‘21:9’ is displayed on a screen of ‘16:9’ according to an exemplary embodiment. As shown in FIG. 19, when a content image 191 having a format of ‘21:9’ is displayed on the screen of ‘16:9’ in a display apparatus 190, the content image 191 is subject to down-scaling with respect to the horizontal and vertical directions in order to fully display the content image 191 having the format of ‘21:9’ on the screen. For instance, the down-scaling is applied to the content image 191 by the same ratio with respect to the horizontal and vertical directions so that the content image 191 can be displayed as a full image 192 without left and right cut-away parts. At this time, the screen may include margins 193 and 194 at upper and lower sides.

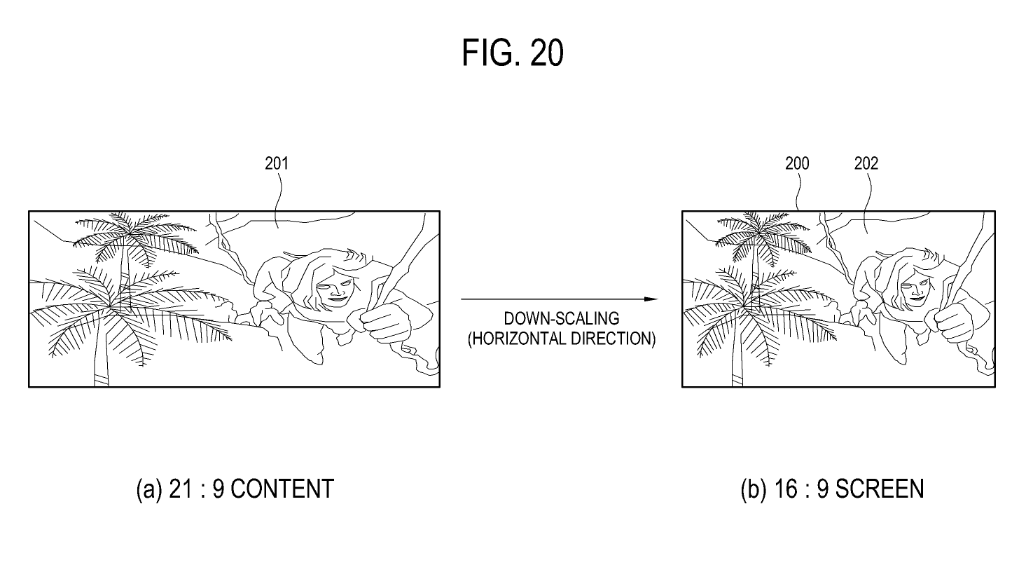

FIG. 20 illustrates an example of applying down-scaling in a horizontal direction when content having a format of ‘21:9’ is displayed on a screen of ‘16:9’ according to an exemplary embodiment. As shown in FIG. 20, in order to display a full area of a content image 201 having a format of ‘21:9’ on a screen of ‘16:9’ of a display apparatus 200 when the content image 201 having the format of ‘21:9’ is displayed on the screen of the display apparatus 200, the down-scaling may be applied to the horizontal direction of the content image 201. For instance, the content image 201 is subject to the down-scaling by a predetermined ratio with respect to only the horizontal direction, so that the content image 201 can be displayed as a full image 202 without cutting away left and light areas or upper and lower areas thereof. In this case, the image may be distorted due to change in density on the screen since only the horizontal direction of the content image 201 is subject to the down scaling.

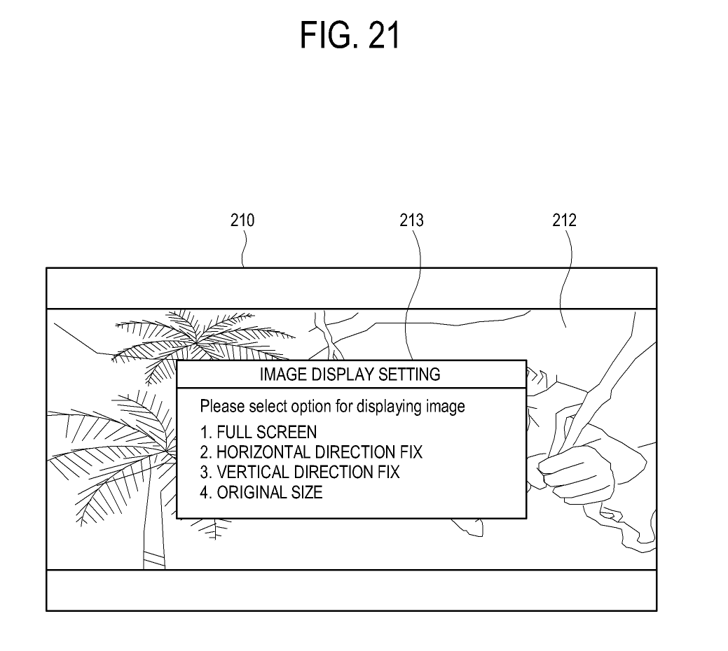

FIG. 21 illustrates an example of a UI for setting display of an image, through which options for displaying an image on screens of various sizes are selectable according to an exemplary embodiment. As shown in FIG. 21, when an image 212 having a format of ‘21:9’ is displayed on a screen of ‘16:9’ in a display apparatus 210, an image display setting UI 213 may be displayed for allowing a user to adjust the size of the image 212 to be displayed on the screen. The image display setting UI 213 includes one or more options selectable by a user in order to display an image in various sizes, and may for example include ‘full screen’, ‘horizontal direction fix’, ‘vertical direction fix’, ‘original size’, etc. By selecting one of the options as desired by a user through the image display setting UI 213, the image is displayed in the selected size.

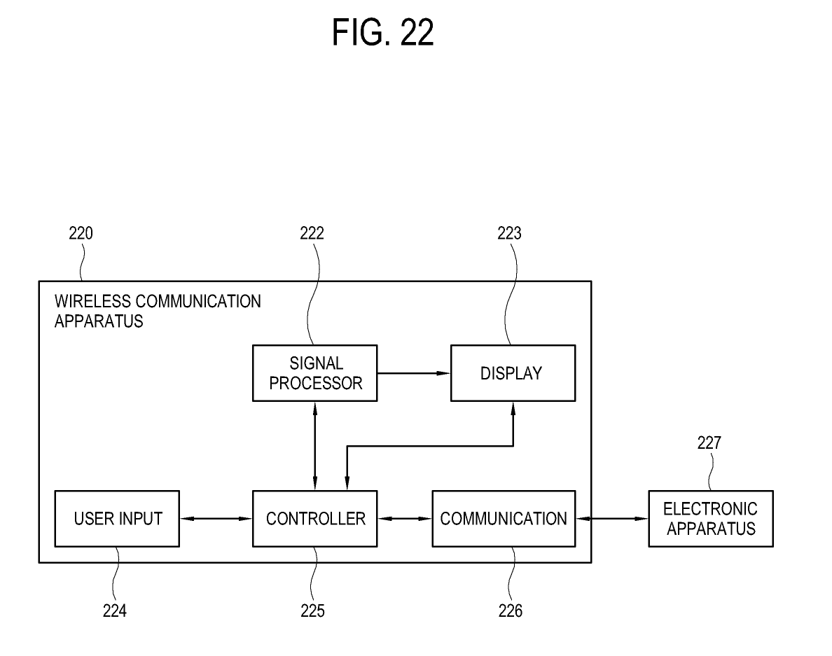

FIG. 22 is a block diagram of a wireless communication apparatus according to an exemplary embodiment. As shown in FIG. 22, a wireless communication apparatus 220 according to an exemplary embodiment includes a signal processor 222, a display 223, a user input 224, a controller 225, and a communicator 226, and may for example be achieved by a smart phone, a tablet computer, a smart TV, etc. Further, the wireless communication apparatus 220 according to this exemplary embodiment performs wireless communication with an electronic apparatus 227, and the electronic apparatus 227 may for example be achieved by a smart TV, a smart phone, a tablet computer, a PC, a netbook, a notebook computer, etc. The wireless communication apparatus 220 according to this exemplary embodiment may further include additional other elements without being limited to the foregoing elements according to this embodiment.

Among the foregoing elements of the wireless communication apparatus 220, the signal processor 222, the display 223 and the user input 224 respectively correspond to the signal processor 12, the display 13 and the user input 14 of the display apparatus 10 shown in FIG. 1, and therefore repetitive descriptions thereof will be avoided. In other words, only different configurations and elements will be described below.

The communicator 226 wirelessly communicates with the electronic apparatus 227 by for example Wi-Fi, Bluetooth or the like communication method. The communicator 226 streams and transmits an image signal having a predetermined resolution to the electronic apparatus 227.

The controller 225 controls the communicator 226 to stream and transmit an image signal having a different resolution to the electronic apparatus 227, in response to a request for the image signal having the different resolution from the electronic apparatus 227.

According to an exemplary embodiment, the controller 225 may execute an application for streaming and transmitting an image signal having a predetermined resolution to the electronic apparatus 227 in response to a user's input. For instance, a user may execute the application in the smart phone so that a stream of an image signal having a resolution of ‘21:9’ can be transmitted to a TV supporting a resolution of ‘16:9’.

According to an alternative embodiment, the controller 225 may receive a request for an image signal having different resolution from the electronic apparatus 227, and change the resolution of the image signal or determine whether there is a file corresponding to the image signal having the different resolution in response to the request. For instance, if the smart phone transmits a stream of an image signal having a resolution of ‘21:9’ to the TV supporting the resolution of ‘16:9’, the TV may make a request for an image signal having a resolution higher than ‘16:9’ to the smart phone in order to stream the image signal having the resolution higher than ‘16:9’. In this case, the smart phone changes the resolution of the streaming image signal to be not lower than ‘16:9’ and not higher than ‘21:9’ in response to the request from the TV and transmits the changed image signal to the TV. Alternatively, the smart phone may search a file corresponding to the image signal having the resolution not lower than ‘16:9’ and not higher than ‘21:9’ in response to the request from the TV, and transmit a stream of the searched image signal to the TV.

Thus, according to this exemplary embodiment, the wireless communication apparatus 220 transmits the stream of the image signal having the different resolution to the electronic apparatus 227, thereby improving a user's viewing area.

As described above, according to an exemplary embodiment, there is provided a display apparatus which receives an image signal different in resolution from an receiving image signal from an external apparatus in response to a user's request and displays an image in a size as desired by a user, thereby improving a user's viewing area.

Further, according to an exemplary embodiment, there is provided a display apparatus which receives and displays an image even when a resolution of an image provided by an external apparatus is different from a resolution supportable by the display apparatus.

Although a few exemplary embodiments have been shown and described, it will be appreciated by those skilled in the art that changes may be made in these exemplary embodiments without departing from the principles and spirit of the present disclosure, the scope of which is defined in the appended claims and their equivalents.

What is claimed is:

1. A display apparatus comprising:
a signal receiver configured to receive a first image signal having a predetermined resolution from an external apparatus;
a signal processor configured to process the received first image signal;
a display configured to have a screen on which a first image of the processed first image signal is displayed; and
a controller configured to:
send a request for an image signal different in resolution from the received first image signal to the external apparatus,
receive a second image signal having the different resolution from the external apparatus,
control the signal processor to adjust a size of a second image of the received second image signal having the different resolution based on a size of the screen of the display, and
control the display to display the second image having the adjusted size.

2. The display apparatus according to claim 1, further comprising an input receiver configured to receive input of a user,
wherein the controller sends a request for the image signal having the different resolution to the external apparatus in response to the received input.

3. The display apparatus according to claim 2, wherein the input comprises at least one of a selection from a user interface menu, input of a shortcut key, voice and motion.

4. The display apparatus according to claim 1, further comprising a storage configured to store information about resolutions supportable by the display apparatus in an memory area to be accessed by the external apparatus for transmitting the second image signal,
wherein the controller changes information stored in the storage in accordance with the different resolution.

5. The display apparatus according to claim 1, wherein the controller sends a request for information about transmittable resolutions to the external apparatus, and controls the display to display a user interface showing information about the transmittable resolutions received from the external apparatus.

6. The display apparatus according to claim 5, wherein the controller selects one transmittable resolution from among the transmittable resolutions in response to a user's input to the user interface, and sends a request for an image signal having the selected resolution to the external apparatus.

7. The display apparatus according to claim 1, wherein the signal processor comprises a scaler configured to apply scaling to the second image of the received second image signal having the different resolution with respect to at least one of a horizontal direction and a vertical direction.

8. The display apparatus according to claim 7, wherein the controller controls the display to display a user setting user interface for allowing a user to set scaling areas and scaling ratios for the second image of the received second image signal having the different resolution, and controls the scaler to apply scaling to the second image of the received second image signal having the different resolution in response to a user's input to the displayed user setting user interface.

9. The display apparatus according to claim 7, wherein the controller controls the display to display an original view area, which corresponds to the received first image signal having the predetermined resolution, and an additional view area, which corresponds to the received second image signal having the different resolution and is added to the original view area, when the second image having the adjusted size is displayed.

10. The display apparatus according to claim 9, wherein the controller applies different scaling ratios to the original view area and the additional view area, respectively.

11. The display apparatus according to claim 7, wherein the controller applies down-scaling to the second image of the second image signal based on the screen size of the display if the second image signal having a resolution higher than the resolution of the received first image signal is received from the external apparatus, and applies up-scaling to the second image of the second image signal based on the screen size of the display if the second image signal having a resolution lower than the resolution of the received first image signal is received from the external apparatus.

12. The display apparatus according to claim 1, wherein the controller sends a request for an image signal different in aspect ratio from the received first image signal to the external apparatus, and receives the second image signal having the different aspect ratio from the external apparatus.

13. The display apparatus according to claim 1, wherein
the external apparatus comprises a wireless communication apparatus wirelessly connected with the display apparatus, and
the controller streams the first image signal having a predetermined resolution from the wireless communication apparatus, sends a request for an image signal different in resolution from the streaming first image signal, and streams the second image signal having the different resolution from the wireless communication apparatus.

14. A wireless communication apparatus comprising:
a display configured to display an image based on an image signal;
a communicator configured to wirelessly connect with an electronic apparatus and stream a first image signal having a predetermined resolution to the electronic apparatus; and
a controller configured to control the communicator to stream and transmit a second image signal different in resolution from the streaming first image signal to the electronic apparatus in response to a request for an image signal having a different resolution from the electronic apparatus.

15. The wireless communication apparatus according to claim 14, wherein the controller executes an application for streaming the first image signal having a predetermined resolution to the electronic apparatus in response to a user's input.

16. The wireless communication apparatus according to claim 14, wherein the controller receives a request for an image signal different in resolution from the streaming first image signal from the electronic apparatus, and changes the resolution of the first image signal into the different resolution or determines whether there is a file corresponding to the second image signal having the different resolution in response to the request.

17. A method of controlling a display apparatus, the method comprising:
receiving a first image signal having a predetermined resolution from an external apparatus;
sending a request for an image signal, which is different in resolution from the received first image signal to the external apparatus;
receiving a second image signal having the different resolution from the external apparatus;
adjusting a size of a second image of the received second image signal having the different resolution based on a size of the screen of the display; and
displaying the second image having the adjusted size.

18. The method according to claim 17, further comprising:
receiving input of a user; and
sending a request for the image signal having the different resolution to the external apparatus in response to the received input.

19. The method according to claim 18, wherein the input comprises at least one of selection from a user interface menu, input of a shortcut key, voice and motion.

20. A method of controlling a wireless communication apparatus, the method comprising:
wirelessly connecting with an electronic apparatus and streaming a first image signal having a predetermined resolution to the electronic apparatus;
receiving a request for an image signal different in resolution from the streaming first image signal from the electronic apparatus; and
streaming a second image signal having the different resolution to the electronic apparatus.
